(19) United States
(12) Patent Application Publication
(10) Pub. No.: US 2024/0207880 A1
(43) Pub. Date: Jun. 27, 2024

(54) TREATMENT SYSTEM AND METHOD FOR TREATING WORKPIECES

(71) Applicant: Dürr Systems AG, Bietigheim-Bissingen (DE)

(72) Inventors: Oliver Seyboth, Hemmingen (DE); Marek Downar, Ditzingen (DE); Karsten Kürschner, Filderstadt (DE); Klaus Heinsohn, Weil der Stadt (DE); Dietmar Wieland, Waiblingen (DE)

(21) Appl. No.: 17/919,915

(22) PCT Filed: Jul. 7, 2022
(86) PCT No.: PCT/DE2022/100488

§ 371 Date: Oct. 19, 2022

(30) Foreign Application Priority Data
Jul. 8, 2021 (DE) 102021207218.6

(51) Int. Cl. B05B 16/40; B05B 16/00; B05C 3/09; B05C 11/10; B05D 1/02; B08B 3/02

(52) U.S. Cl. CPC B05B 16/40; B05B 16/95; B05C 3/09; B05C 11/10; B05D 1/02; B08B 3/022

(57) ABSTRACT

In order to provide a treatment system for treating workpieces, in particular for performing a fluid treatment on vehicle bodies, which is simple in design and enables an efficient workpiece treatment, it is proposed that the treatment system comprises the following: an enclosure which surrounds a treatment chamber, a conveying device for conveying the workpieces; an application device for applying fluid to the workpieces.

### RELATED APPLICATION

This application is a national phase of international application No. PCT/DE2022/100488 filed on Jul. 7, 2022, and claims the benefit of German application No. 10 2021 207 218.6 filed on Jul. 8, 2021, which are incorporated herein by reference in their entirety and for all purposes.

### FIELD OF DISCLOSURE

The present invention relates to the field of treatment systems for treating workpieces. A treatment system is in particular a fluid treatment system for performing a fluid treatment on vehicle bodies, for example in the manufacture of motor vehicles, in particular passenger cars.

### BACKGROUND

For example, for degreasing or for cleaning or for pre-treating vehicle bodies before carrying out a painting process, it can be provided that vehicle bodies are introduced into an immersion bath.

### SUMMARY OF THE INVENTION

The problem addressed by the present invention is that of providing a treatment system which has a simple structure and provides for efficient workpiece treatment.

According to the invention, this problem is solved by a treatment system according to claim 1.

The treatment system for treating workpieces is in particular a treatment system for carrying out a fluid treatment on vehicle bodies, in particular as a component of a manufacturing process for the manufacture of vehicles.

The treatment system preferably comprises an enclosure which surrounds a treatment chamber.

Furthermore, the treatment system preferably comprises a conveying device by means of which at least one workpiece can be introduced into the treatment chamber and/or can be guided through the treatment chamber and/or can be discharged from the treatment chamber.

It may be favorable if the treatment system comprises an application device for applying fluid to the at least one workpiece.

The fluid is in particular a treatment fluid. In particular, the fluid is present in liquid form for performing the treatment.

The fluid is, for example, heated fluid, in particular fluid at a temperature of 60° C. or more, for example 80° C. or more.

Alternatively or additionally, it can be provided that the fluid is water or is or comprises a surfactant-containing and/or alkaline aqueous solution. Such a fluid is suitable in particular for spray degreasing and/or immersion degreasing of workpieces.

The fluid can also be, for example, fresh water or demineralized water or comprise fresh water and/or demineralized water. Such a fluid is particularly suitable for spray rinsing and/or immersion rinsing of workpieces.

Furthermore, the fluid can, for example, be or comprise a phosphate-based or silane-based chemical coating medium. Such a fluid is particularly suitable for performing a coating process.

It can be provided that the application device comprises one or more application units for applying fluid to the at least one workpiece.

The one or more application units preferably each comprise one or more spray nozzles and/or atomizing nozzles or are designed as one or more spray nozzles and/or atomizing nozzles.

In one embodiment of the invention, it can be provided for the treatment chamber to be a single chamber in which only a single workpiece can be or is received at a given point in time.

Alternatively, it can be provided for the treatment chamber to be a chamber in which several workpieces can be received simultaneously at a given time.

It can be advantageous if the workpiece can be introduced into the treatment chamber in an insertion direction, by means of the conveying device, and can be discharged from the treatment chamber counter to the insertion direction.

Alternatively, it can be provided that at least one workpiece can be introduced into a treatment chamber by means of the conveying device, in an insertion direction, and can be discharged from the treatment chamber in the same direction, in particular at an opposite end of the treatment chamber.

It can be provided that the treatment chamber is equipped with application units of the application device on a plurality of sides.

For example, it can be provided that the workpiece and/or a part of the treatment chamber accommodating the workpiece is surrounded on a plurality of sides, in particular on two sides, on three sides or on four sides, by one or more application units of the application device.

For example, it can be provided that the application device comprises a plurality of application units on side walls that are arranged opposite to each other, in particular spray nozzles and/or atomizing nozzles.

By means of the application device, fluid can be applied in particular at the same time to a plurality of sides of a workpiece, in particular a plurality of sides of the workpiece lying opposite one another and/or facing away from one another.

It can be advantageous if the workpiece is movable, in particular linearly displaceable, in the treatment chamber, and the application units are preferably arranged statically, i.e., in particular non-pivotably and/or non-displaceably, the workpiece preferably being movable by means of the conveying device or a movement device. As a result, a relative movement of the workpiece relative to the application units of the application device can optionally be produced.

It may be favorable if the workpiece can be moved back and forth at least once in the direction of movement by more than half the distance between two adjacent application units, so that, as a result of the relative movement of the workpiece relative to the application units, fluid is applied to the workpiece uniformly and/or completely.

It can be advantageous here if the relative movement of the workpiece relative to the application units can be controlled by means of at least one initiator, for example a proximity sensor arranged within the treatment chamber, the at least one initiator advantageously having protection class IP69k according to DIN EN 60529.

Additionally or alternatively, it can be provided that the relative movement of the workpiece relative to the application units is controlled by means of at least one incremental encoder or in terms of time, in particular with specification of a movement sequence.

Furthermore, it can additionally or alternatively be provided that the relative movement of the workpiece relative to the application units is controlled by means of at least one initiator which is arranged outside the treatment chamber and detects and/or monitors the movement of a lever device guided out of the treatment chamber.

It can be advantageous if the treatment chamber is longer in the direction of movement of the workpiece than the workpiece itself, in particular at least twice as long as half the distance between two adjacent application units, so that a reciprocating movement of the workpiece relative to the application units of the application device is possible without the workpiece touching the treatment chamber.

It can also be advantageous if the acceleration of the relative movement is variable or adjustable. It may be particularly advantageous if the acceleration of the relative movement of the workpiece is at least about 0.1 m/s², preferably at least about 0.25 m/s², and/or at most about 5 m/s², preferably at most about 2 m/s². As a result, the workpiece preferably undergoes such moderate acceleration, in the respective direction of the relative movement, that spinning of the drive rollers of the conveying device is advantageously prevented.

It can be provided that the treatment chamber comprises a closing device for partially or completely closing an access opening of the treatment chamber, through which the at least one workpiece can be introduced into the treatment chamber and/or through which the at least one workpiece can be discharged from the treatment chamber.

The closing device is designed, for example, as a roller gate or a sliding gate or a lifting gate.

It can be provided that the closing device is a splash guard for closing the treatment chamber and/or for preventing fluid from spraying out. Such a splash guard is preferably not pressure-resistant against a fluid level rising in the treatment chamber.

Alternatively, it can be provided that the closing device is a pressure-tight closing device, in particular a lock gate, by means of which the access opening of the treatment chamber can be closed in a fluid-tight manner also against an increase of a fluid level within the treatment chamber.

It may be provided for the conveying device to be a clocked conveying device.

The at least one workpiece is preferably spatially stationary, in particular fixed, for carrying out a treatment. The at least one workpiece is in particular spatially stationary, in particular fixed, by means of the conveying device and/or a fixing device provided in addition to the conveying device, while the treatment is being carried out.

It can be advantageous if the treatment system comprises a feed tank which is arranged in particular above the treatment chamber. Fluid can preferably be supplied from the feed tank to the application device. The fluid can preferably be applied to the at least one workpiece by means of the application device.

By arranging the feed tank above the treatment chamber, a pump for driving the fluid can preferably be dispensed with.

The fluid can then be supplied, in particular solely due to gravity, from the feed tank to the application device and can be applied to the at least one workpiece.

As an alternative or in addition to a feed tank, it can be provided in particular that the treatment system comprises a discharge tank. The discharge tank is in particular arranged below the treatment chamber. Fluid applied to the at least one workpiece can preferably be guided from the treatment chamber into the discharge tank, in particular can be discharged into the discharge tank exclusively due to gravity. A pump is preferably dispensable for this purpose.

It can be advantageous if the treatment system comprises a pump for driving the fluid, in particular for supplying the fluid from the discharge tank back into the feed tank. In this case, a processing device, in particular a filter device or other cleaning device for cleaning the fluid, can be provided in a line which connects the discharge tank to the feed tank. Impurities cleaned off the workpiece in a treatment process can thereby be separated from the fluid in order to thus provide exclusively non-contaminated fluid or at least optimally processed and/or cleaned fluid for treating workpieces.

As an alternative or in addition to cleaning the fluid, temperature control or other processing of the fluid can be provided for preparing a subsequent treatment process.

It may be favorable if the application device comprises at least one application unit which is designed as at least one application lance.

At least one application unit, in particular at least one application lance, can preferably be introduced into an interior of the at least one workpiece or is arranged and/or formed so as to protrude into the interior in a treatment state of the workpiece.

By means of the at least one application unit, in particular by means of the at least one application lance, fluid can preferably be applied to surfaces of the at least one workpiece facing an interior of the at least one workpiece.

It may be favorable if the application lance and/or the workpiece can be moved, in particular linearly displaced, in order to be able to apply fluid to all regions in the interior of the workpiece by means of the application lance.

It can be advantageous if fluid can be applied to an outer surface of the at least one workpiece facing away from an interior of the at least one workpiece by means of one or more application units, fluid preferably being able to be applied to surfaces of the at least one workpiece facing the interior of the at least one workpiece by means of at least one further application unit simultaneously and/or in a temporally offset and/or temporally successive manner.

It may be favorable if the enclosure is at least partially floodable, in particular up to a height of at least approximately 40%, preferably at least approximately 60%, of a maximum spatial height of the enclosure and/or of the treatment chamber and/or of a maximum height of the workpiece.

In this case, the term “floodable” is to be understood in particular to mean that liquid can be supplied in such a way that the liquid accumulates within the enclosure and thus a liquid level rises. In this case, side walls and/or one or more closing devices of the enclosure are preferably designed so as to be liquid-tight, and withstand the liquid pressure resulting from the filling process.

A flooding apparatus for flooding the enclosure can be provided as an alternative or in addition to one or more application devices.

In particular, it can be provided that fluid can be applied to the at least one workpiece by means of one or more application devices during the flooding process and/or after the flooding process has taken place, in particular during emptying of the enclosure, for example for rinsing out impurities from the workpiece.

Furthermore, it can be provided that fluid is applied to the workpiece in part by flooding the enclosure and in part by applying fluid by means of the application device in order to carry out a treatment process. In this case, fluid can be applied in particular to a sill region and/or a floor region of a workpiece designed as a vehicle body by means of flooding. As a result, fluid can be applied in particular to cavities within the sill and/or the floor region which are or would be difficult to access by atomizing and/or spraying. In particular one or more hood regions, A-pillars, B-pillars, C-pillars and/or a roof region of a workpiece designed, for example, as a vehicle body, can preferably be sprayed with fluid in parallel to this, by means of an application device, in order to carry out a treatment process.

The treatment is preferably a cleaning treatment, in particular degreasing.

Furthermore, it can be provided that the treatment is or comprises a chemical and/or physical surface treatment.

It can also be provided that the treatment is a coating.

The present invention further relates to a method for treating workpieces, in particular for carrying out a fluid treatment on vehicle bodies.

In this respect, the problem addressed by the invention is that of providing a method by means of which a workpiece treatment can be carried out efficiently.

According to the invention, this problem is solved by the features of the independent method claim.

The method for treating workpieces preferably comprises introducing at least one workpiece into a treatment chamber and/or conveying at least one workpiece through the treatment chamber. Furthermore, the method preferably comprises applying fluid to the at least one workpiece by means of an application device.

The method according to the invention preferably comprises one or more of the features and/or advantages described in connection with the treatment system.

Furthermore, the treatment system according to the invention preferably comprises one or more features of the method according to the invention.

It may be favorable if fluid is applied at least to the outer surfaces of the at least one workpiece at least approximately uniformly and/or simultaneously.

Alternatively or in addition hereto, it can be provided that fluid is applied at least to the inner surfaces of the at least one workpiece at least approximately uniformly and/or at least approximately simultaneously.

Preferably, fluid is applied both to the outer surfaces and to the inner surfaces of the at least one workpiece at least approximately uniformly and/or at least approximately simultaneously.

The fluid is preferably applied over a large area, in particular on an area of at least approximately 50%, preferably at least approximately 80%, in particular at least approximately 90%, of a total surface area of the workpiece, in particular applied at least approximately simultaneously.

Preferably, the fluid is applied uniformly to the surfaces of the at least one workpiece in such a way that a fluid pressure and/or an amount of fluid and/or a fluid volume is the same at each point of the surfaces acted on by the fluid, with less than approximately 30% variation, preferably less than approximately 20% variation.

It can be advantageous if the fluid is applied to the at least one workpiece during a fluid process for at least partial flooding of the treatment chamber and/or during an emptying process after flooding has taken place.

For optimized workpiece treatment, it can further be provided that fluid is applied to the at least one workpiece in a first treatment chamber by atomization and/or spraying, and that the same fluid and/or another fluid is subsequently applied to the at least one workpiece in a second treatment chamber different from the first treatment chamber, by flooding the second treatment chamber.

Alternatively, it can be provided that one or more fluids are applied to the workpiece in one and the same treatment chamber both by atomization and/or spraying and by flooding.

In particular for optimizing a treatment step, it can be provided that, during a flooding process for performing a workpiece treatment, a flow is generated in the flooded part of the treatment chamber. The at least one workpiece can thereby be subjected to optimized inflow in order to optimize the treatment, for example in order to release impurities in a simplified manner. Furthermore, air bubbles can preferably be expelled thereby, in order to be able to completely wet cavities and interior spaces.

A flow can be produced for example by flooding nozzles. Alternatively or additionally, pumps for generating a flow can be provided in the treatment chamber.

Furthermore, an agitator and/or a nozzle device, for example one or more swivel nozzles, can be provided as an alternative or in addition to the generation of a flow, in order to optimize an inflow onto and/or flow through the at least one workpiece.

In particular if both a flooding process and an application process are provided by spraying and/or atomizing fluid, it can be provided that, after carrying out a flooding process, in particular a flooding process for workpiece treatment, a fluid that is different from the fluid used for flooding is used for spraying and/or rinsing the at least one workpiece. As a result, it is possible to prevent in particular a treatment process, for example a chemical surface treatment process, immediately after the fluid is discharged from the treatment chamber, or even during said discharge, in the part of the at least one workpiece protruding from the fluid.

Furthermore, rinsing of the at least one workpiece by spraying and/or atomizing fluid onto the at least one workpiece can serve to remove dirt particles and/or foam or other contaminants adhering to the at least one workpiece when the fluid used for flooding is discharged from the at least one workpiece.

Fluid used in a treatment process can be used, in particular after processing, in particular filtering and/or temperature control, thereof, in order to carry out the same treatment process on a further workpiece. In particular, if impurities accumulate in the fluid after several treatment processes, it can be provided, however, that a fluid is used after carrying out a treatment process for performing another treatment process, in particular a treatment process of another type. In this case, the fluid can in particular be optionally discharged into different discharge tanks in order to be made available to different treatment processes, in particular depending on the respective degree of contamination of the fluid.

In particular for the subsequent rinsing of outer surfaces or other surfaces, it can be provided that processed fluid, for example a fluid that has undergone nanofiltration or ultrafiltration, is used for this purpose. In particular, high-purity filtrate is used for a spraying process and/or atomizing process, while concentrate is again fed to the remaining fluid, in particular for performing flooding processes. In particular, a post-rinsing process can thereby preferably be carried out using high-purity fluid for an optimized rinsing effect, at the same time preferably an overall composition of the fluid remaining unchanged, in particular after renewed mixing of the filtrate and the concentrate in the discharge tank.

According to a further aspect of the present invention, it can be provided that the treatment comprises a degreasing process and/or a rinsing process and/or a coating process.

By means of the application device, the fluid can preferably be applied to the workpiece in one or more temporally varying atomization patterns or spray patterns.

An atomization pattern or spray pattern is in particular a pattern or image on the surface of the workpiece which results from the geometry of a fluid jet.

The application device preferably comprises one or more rotatable or rotating application units, by means of which a rotating atomization pattern or spray pattern can be generated on the workpiece.

A rotating atomization pattern or spray pattern results in particular from a temporal variation of the point of impingement of the atomization jet or spray jet, which is dispensed onto the workpiece by means of the one or more application units. In this case, a region which is acted on uniformly, on average, in particular an at least approximately rotationally symmetrical overall spray pattern or overall atomization pattern, preferably results.

At a given point in time, a locally varying atomization pattern or spray pattern is preferably produced by means of a rotating or rotatable application unit, which atomization pattern or spray pattern develops in the temporal average with respect to the uniform overall spray pattern or overall atomization pattern only by rotation.

It can be provided that the application device has a plurality of application units which are coupled and/or synchronized with one another. In this case, the one or more application units are preferably coupled and/or synchronized with one another in such a way that atomization jets or spray jets applied by the application units to the workpiece always impinge on different surface regions of the workpiece at any desired time.

For example, it can be provided that adjacent application units and/or atomization jets and/or spray jets are designed so as to be counter-rotating.

As an alternative or in addition thereto, it can be provided for a plurality of adjacent application units and/or atomization jets and/or spray jets to be designed so as to rotate in the same direction.

By means of a plurality of the application units of the application device, overlapping overall atomization patterns or overall spray patterns can preferably be generated on the workpiece. In particular, an at least approximately uniform action of fluid on the workpiece can be achieved by means of the plurality of application units.

At a given time, however, the atomizing jets or spray jets are preferably always directed to different points of the workpiece. In particular, simultaneous action on one region by a plurality of atomizing jets or spray jets from different application units is thereby preferably prevented.

The application device preferably comprises a plurality of application units which are movable, in particular rotatable, together by means of a distributor device of the application device for supplying the fluid to the application units.

The distributor device can be, for example, a distributor pipe and/or a spray arm. The distributor device is preferably a rotor which comprises a plurality of application units arranged at different distances from the axis of rotation with respect to an axis of rotation. In this case, the axis of rotation is in particular substantially perpendicular to a longitudinal axis of the rotor. The rotor can be rotationally driven, for example by means of a turbine wheel and/or by means of a transmission in the interior of the application device, in particular in the interior of the distributor device, using the fluid as a drive. As an alternative or in addition thereto, rotational driving of the rotor can be achieved by recoil, by means of a suitable inclination of outlet openings of the application units.

It can be advantageous if a rotational movement of the at least one rotor can be monitored, controlled and/or regulated by means of one or more sensors, in particular magnetic-inductive sensors.

It may be favorable if the application device comprises a plurality of application units each comprising one or more distributor devices, in particular according to one of the embodiments described above. The distributor devices are arranged in particular at different heights and/or having mutually parallel axes of rotation and/or along the axes of rotation, with respect to one another, in particular in order to enable a free movement of the respective distributor devices and at the same time an overlap of the regions to which fluid is to be applied by means of the respective application units, in particular to ensure overlapping overall atomization patterns or overall spray patterns.

It can be advantageous if, during an application process for applying fluid to the at least one workpiece, the at least one workpiece is movable, in particular linearly displaceable, by means of the conveying device.

For example, a linear displacement in one direction and then a linear displacement in an opposite direction can be provided in this case, or only a single linear displacement in one direction, in order to apply fluid to the at least one workpiece uniformly by means of the application device.

It can be advantageous if the fluid can be applied by means of the application device both to an outer surface of the at least one workpiece, in particular to an outer visible surface, and to an inner surface of the at least one workpiece, in particular a surface of an interior space.

It may be favorable if the application device comprises a plurality of application units which are arranged in a regular and/or grid-like and/or matrix-like pattern.

In particular, it can be provided for a plurality of application units, which are arranged in particular in a regular and/or grid-like and/or matrix-like pattern, to be arranged on mutually opposite side walls of the treatment chamber, in particular the enclosure of the treatment chamber, in each case.

A grid-like or matrix-like pattern is to be understood in particular to mean patterns in which a plurality of rows or lines or elements arranged in succession in a pattern in another manner, in particular application units, are provided. In particular, a plurality of application units arranged in horizontal and vertical lines or rows are provided.

It may be favorable if one or more application units are arranged outside a central region of the at least one workpiece, in particular with respect to a height direction of the workpiece, in particular only in an upper region and/or a lower region of the at least one workpiece.

As a result, a width of the treatment chamber can be minimized.

The application device, in particular the application units of the application device, surround the treatment chamber accommodating the at least one workpiece or the part of the treatment chamber surrounding the at least one workpiece substantially in a portal-like and/or cage-like manner and/or at least on three sides.

It may be favorable if one or more application units, in particular a plurality of application units arranged in a regular and/or grid-like and/or matrix-like pattern, are fluidically movable, in particular linearly movable, during application.

In this case, the movement can in particular be a movement in an at least approximately vertical direction, in an at least approximately horizontal direction, or obliquely thereto.

In one embodiment of the invention, it can be provided for one or more application units to be designed to be rotatable or pivotable.

In particular, vertically or horizontally arranged rows or lines of application units can be designed to be rotatable or pivotable together, for example to achieve a varying rotational orientation of at least approximately +20°, preferably at least approximately +30°, starting from a central position.

During the application of fluid, the at least one workpiece is preferably moved, in particular linearly displaced. Alternatively or in addition thereto, one or more application units of the application device are preferably moved, in particular rotated or pivoted, during the application of fluid.

Further preferred features and/or advantages of the invention form the subject matter of the following description and the drawings illustrating embodiments.

### BRIEF DESCRIPTION OF THE DRAWINGS

FIG. 1 is a schematic perspective view of a first embodiment of a treatment system in which a fluid can be applied to a workpiece by means of an application device;

FIG. 2 is a further schematic perspective view of the treatment system of FIG. 1;

FIG. 3 is a schematic perspective view of a second embodiment of a treatment system in which a combination of a flooding device and an application device for carrying out treatment processes is provided;

FIG. 4 is a further schematic perspective view of the second embodiment of a treatment system according to FIG. 3;

FIG. 5 is a schematic vertical cross-section through a third embodiment of a treatment system in which a treatment chamber is provided on three sides with application units of an application device;

FIG. 6 is a schematic side view of the treatment system of FIG. 5 with a view in its interior space;

FIG. 7 is a schematic plan view of the treatment system of FIG. 5, with a view in its interior space;

FIG. 8 is a schematic view corresponding to FIG. 5, of a fourth embodiment of a treatment system in which pivotable application units are provided;

FIG. 9 is a schematic view, corresponding to FIG. 6, of the treatment system of FIG. 8;

FIG. 10 is a schematic view, corresponding to FIG. 5, of a fifth embodiment of a treatment system in which an application device with rotating distributor devices of the application device is provided;

FIG. 11 is a schematic view, corresponding to FIG. 6, of the treatment system of FIG. 10;

FIG. 12 is a schematic view, corresponding to FIG. 7, of the treatment system of FIG. 10;

FIG. 13 is a schematic view, corresponding to FIG. 6, of a treatment system which comprises a lance-shaped application unit;

FIG. 14 is a schematic view, corresponding to FIG. 6, of a sixth embodiment of a treatment system in which a combination of flooding treatment and spray or atomization treatment is provided; and

FIG. 15 is a schematic view, corresponding to FIG. 7, of the treatment system of FIG. 14.

The same or functionally equivalent elements are provided with the same reference signs in all figures.

### DETAILED DESCRIPTION OF THE DRAWINGS

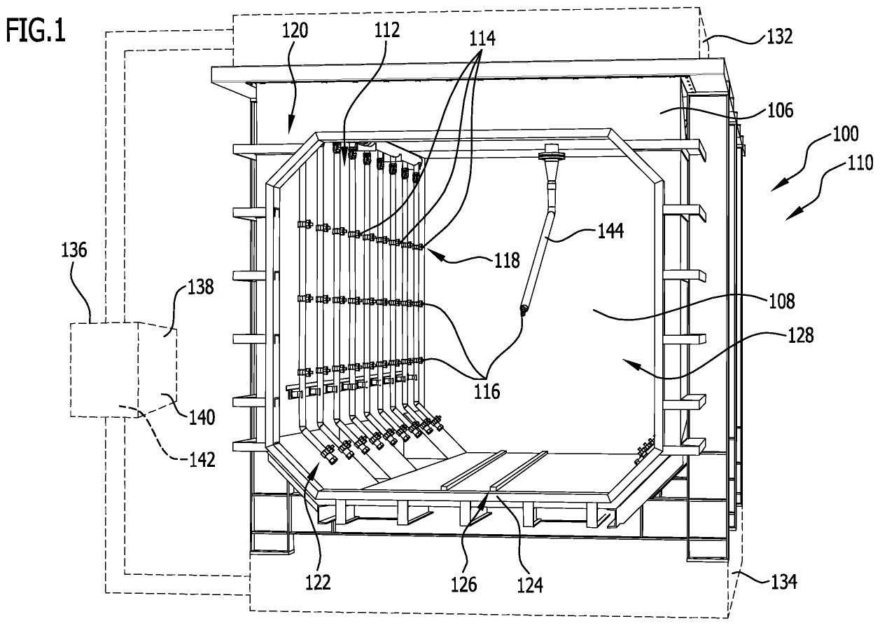

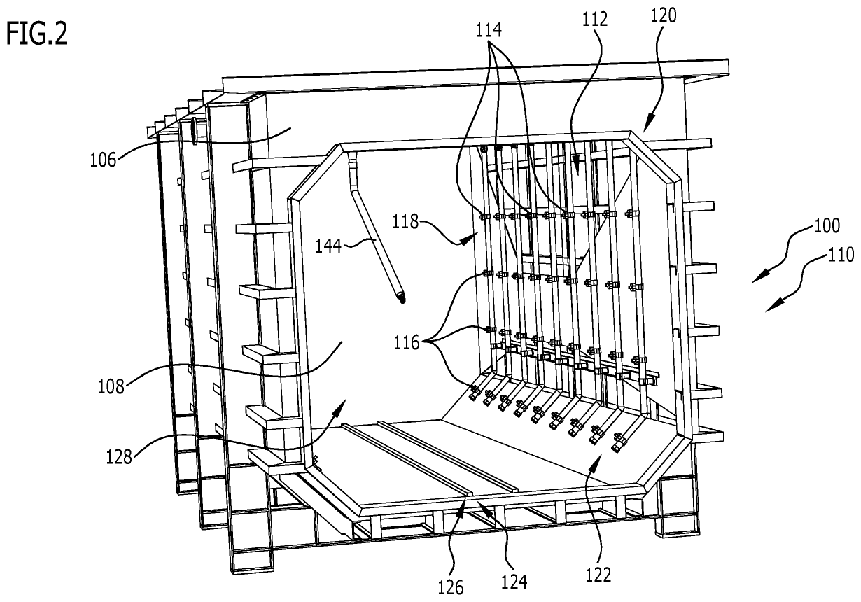

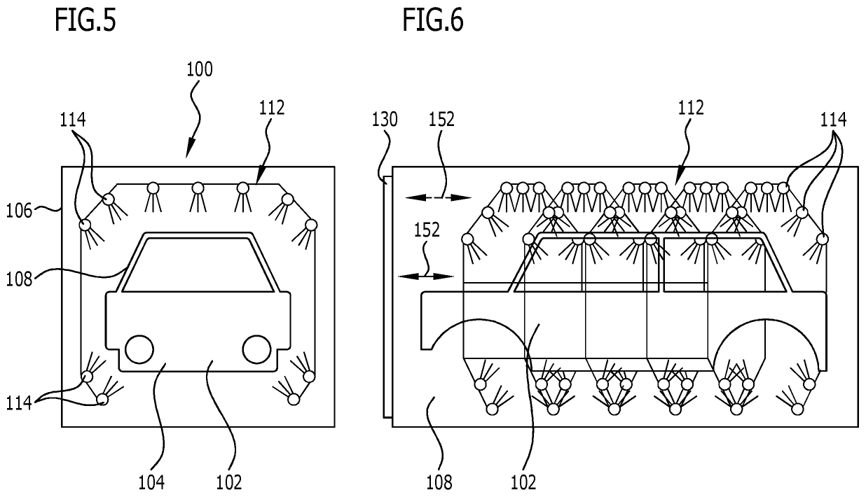

A first embodiment, shown in FIGS. 1 and 2, of a treatment system designated as a whole by 100 serves to treat workpieces 102, for example vehicle bodies 104 (not shown in FIGS. 1 and 2, but indicated in FIGS. 5 et seqq.).

The treatment system 100 comprises an enclosure 106, which is, for example, a metallic, box-shaped, in particular cuboid, enclosure.

The enclosure 106 comprises in particular a plurality of side walls which surround a treatment chamber 108 of the treatment system 100.

The embodiment of the treatment system 100 shown in FIGS. 1 and 2 forms in particular a treatment station 110 for treating workpieces 102. In the case of larger treatment systems 100, in particular a plurality of such treatment stations 110 can be provided.

In order to carry out a treatment, the treatment system 100 comprises an application device 112, which in particular comprises a plurality of application units 114, for example spray nozzles 116. In this detailed description, reference is generally made to “spray nozzles” for applying fluid, in particular liquid. Alternatively thereto and/or depending on the desired boundary conditions during application of the fluid, “atomizing nozzles” can also be provided instead of such spray nozzles 116.

The application units 114 are in particular arranged in at least approximately horizontal lines 118 and/or in at least approximately vertical rows 120. For example, a matrix-like or grid-like arrangement of the application units 114 is provided.

The application units 114 in particular form a nozzle matrix 122 of the application device 112.

The application units 114 are preferably arranged on one of the side walls of the enclosure 106 and aligned in the direction of a center of the treatment chamber 108, in particular in order to be able to apply fluid to a workpiece 102 arranged in the center of the treatment chamber 108.

As can be seen in particular from a comparison of FIGS. 1 and 2, in this embodiment opposite side walls of the enclosure 106 are each provided with a nozzle matrix 122.

The treatment system 100 further comprises a conveying device 124 for introducing at least one workpiece 102 into the treatment chamber 108 and/or for passing at least one workpiece 102 through the treatment chamber 108 and/or for conveying at least one workpiece 102 out of the treatment chamber 108. The conveying device 124 is in particular a clocked conveying device 126. In the case of such a clocked conveying device 126, it is provided in particular that a workpiece 102 to be treated is locked in a predetermined treatment position, in particular fixed by means of an optional fixing device. As a result, a predetermined position relationship with the application units 114 can be achieved, in order to ensure reliable workpiece treatment during standstill.

The enclosure 106 is in particular accessible through a lateral access opening 128. For example, a workpiece 102 can be introduced through the access opening 128 into the treatment chamber 108 by means of a roller conveyor or rail conveyor (not shown) which forms the conveying device 124.

A closing device 130, merely indicated in FIG. 6, serves to close the treatment chamber 108 and is preferably also provided in the other embodiments. By means of the closing device 130, in particular the escape of liquid into an environment of the enclosure 106 can be prevented.

The closing device 130 is, for example, a roller gate or a lock gate, in particular depending on whether the closing device 130 is intended to serve only as a splash guard or also for fluid-tight closing of the treatment chamber 108 during a flooding process.

As indicated in FIG. 1, the treatment system 100 preferably comprises a feed tank 132 and a discharge tank 134.

The feed tank 132 preferably serves to supply fluid to the application device 112. Preferably, the feed tank 132 is arranged above the treatment chamber 108 with respect to a direction of gravity.

The fluid located in the feed tank 132 can thus be fed to the application device 112 in particular without using a pump, merely due to gravity, in order to ultimately be applied to the workpiece 102. Optionally, an additional pump can be provided, in particular for increasing the pressure.

The discharge tank 134 is preferably arranged below the enclosure 106 with respect to the direction of gravity. The fluid provided in the treatment chamber 108 can thus flow in a particularly simple manner into the discharge tank 134, in particular without using a pump, which, however, can also optionally be provided in addition.

The fluid can preferably be used multiple times, in particular for carrying out several treatment processes on a plurality of workpieces 102.

For this purpose, the treatment system 100 preferably comprises a pump 136, by means of which the fluid can be conveyed in particular from the discharge tank 134 into the feed tank 132.

Optionally, in particular a processing device 138, for example a cleaning device 140 and/or a temperature control device 142, can be provided.

By means of the processing device 138, in particular the fluid can be processed before being fed to the feed tank 132, for example by filtering out suspended matter and other impurities which could impair a treatment result.

The fluid can be pumped, on the one hand, from the discharge tank 134 of the treatment system 100 into the feed tank 132 of the same treatment system 100, in particular of the same station 110 of the treatment system 100. The fluid is then provided in particular for carrying out the same treatment process. Alternatively thereto, it can be provided that the fluid is supplied in cascade-like succession to different treatment stations 110 for carrying out treatment processes of different types. For example, depending on a degree of contamination of the fluid, its use can be provided at rinsing stations having different purity requirements.

In the embodiment of the treatment system 100 shown in FIGS. 1 and 2, a workpiece 102 can be acted on by fluid over a large area, in particular from both sides.

It may be favorable if the treatment system 100 further comprises an application unit 114 which can be inserted into an interior of the workpiece 102. Such an application unit 114 is, for example, the application lance 144 in FIGS. 1 and 2.

The application lance 144 preferably protrudes into the treatment chamber 108. By introducing a workpiece 102 by means of the conveying device 124, it is preferably pushed onto the application lance 144, in particular while avoiding contact with the application lance 144. The application lance 144 protrudes into the interior of the workpiece 102 in a treatment position of the workpiece 102.

In particular a spray nozzle 116, for example a rotating spray nozzle 116, is arranged at the end of the application lance 144 in order to be able to apply fluid to the interior of the workpiece 102. In further embodiments, a plurality of spray nozzles 116, in particular movable and/or rotating spray nozzles 116, can also be provided at the end of the application lance 144, in order to enable the application of a sufficient amount of fluid and uniform wetting, over a large surface area, of the surfaces in the interior of the workpiece 102. Furthermore, an application unit 114 designed as a spray ball or rotation cleaner can be arranged at the end of the application lance 144.

In addition, one or more surge nozzles can also be provided, in order to be able to introduce a large quantity of the fluid into the interior of the workpiece 102. Coarse impurities and impurities cleaned off by means of the application lance 144 can thus be easily rinsed out of the workpiece 102.

The application lance 144 can also preferably be used for cleaning the treatment chamber 108 itself, in particular in the absence of a workpiece 102.

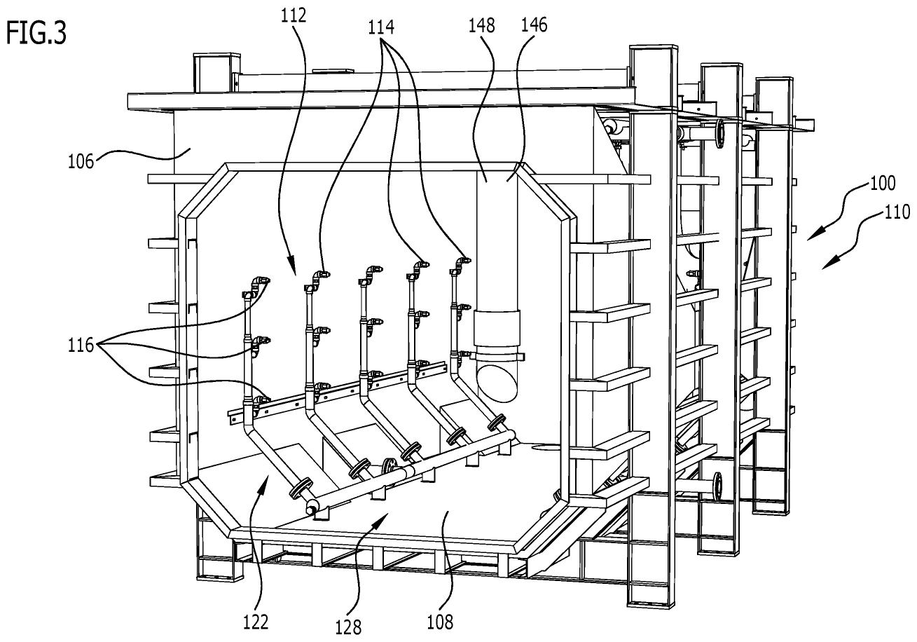

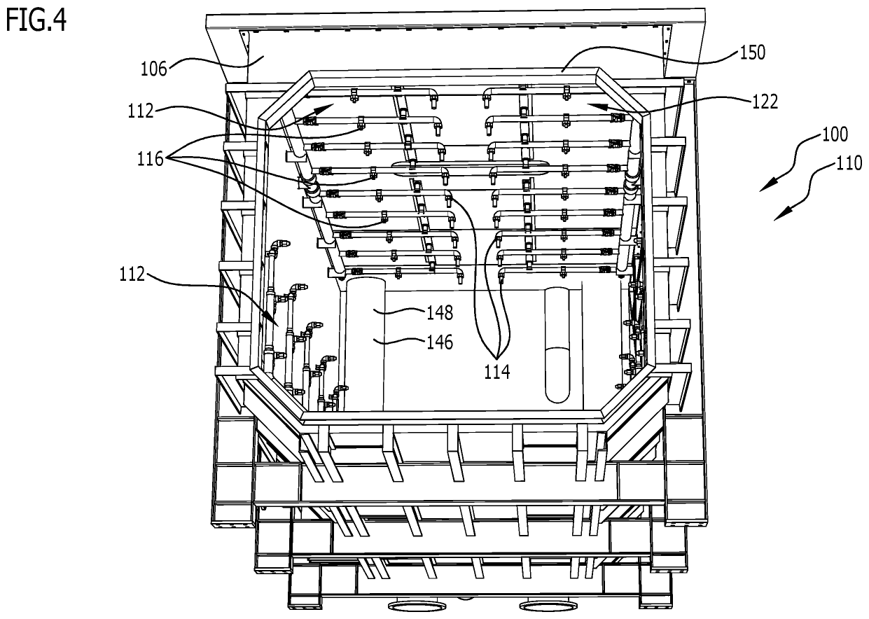

An alternative embodiment of a treatment system 100 shown in FIGS. 3 and 4 differs from the embodiment shown in FIGS. 1 and 2 substantially in that the treatment system 100 allows both for spray application or atomizing application by means of an application device 112, and for a flooding process to be carried out. In this case, the closing device (not shown) is in particular designed to be pressure-resistant in order to enable a rising fluid level in the treatment chamber 108 and to prevent fluid from escaping.

The embodiment of the treatment system 100 shown in FIGS. 3 and 4 comprises in particular a flooding device 146 for carrying out the flooding process. In this case, in particular a flood tube 148 of the flooding device 146 is provided, which leads from a feed tank 132 (not shown in FIGS. 3 and 4) into the treatment chamber 108. The flood tube 148 opens in particular into a lower region of the treatment chamber 108 with respect to the direction of gravity.

The flood tube 148 has in particular a diameter which is significantly larger than the line diameter of the application device 112, for example by a factor of at least 2, preferably at least 5. As a result, a particularly large amount of fluid can preferably be introduced into the treatment chamber 108 in a short time.

The application device 112 in the second embodiment of the treatment system 100 serves, for example, for the application of fluid in order to carry out a treatment process, it being possible for said treatment process to be a chemical or physical treatment or also cleaning as well as simple rinsing.

The application device 112 preferably has a part which can be seen in FIG. 4 and is arranged on a top wall 150 of the enclosure 106 of the treatment system 100.

In particular, a nozzle matrix 122 is arranged on the top wall 150.

As an alternative to nozzles, the application units 114, which are arranged on the top wall 150, can also be drip elements or simple line ends, in order to dispense fluid onto the workpiece 102 in a dropwise or surge-like manner.

Different portions of the application device 112 can optionally be supplied with different fluids. For example, a treatment fluid for performing a physical or chemical treatment can be applied by means of lateral application units 114, while a rinsing fluid can be supplied, for example, via the application units 114 arranged on the top wall 150.

The flooding device 146 and the application device 112 preferably interact with one another in such a way that, after a flooding process is carried out by means of the application device 112, a rinsing process is carried out, in particular in order to remove, from the workpiece 102, foam and other floating impurities, which can adhere to the workpiece 102 at the end of the flooding process when the fluid is discharged. Furthermore, the application device 112 and the flooding device 146 can of course also serve together for the application of the same treatment fluid.

Otherwise, the second embodiment of the treatment system 100 shown in FIGS. 3 and 4 corresponds, in terms of structure and function, to the embodiment shown in FIGS. 1 and 2, and therefore reference is made, in this respect, to the above description thereof.

A third embodiment of a treatment system 100 shown in FIGS. 5 to 7 differs from the first embodiment shown in FIGS. 1 and 2 substantially in that the application units 114 of the application device 112 are arranged so as to be distributed around a part of the treatment chamber 108 that serves for receiving the workpiece 102. In this case, the application units 114 are in particular arranged in a sill region of a workpiece 102, designed as a vehicle body 104, and in a roof region.

As can be seen in particular from the arrows in FIG. 6, a movement device 152 can optionally be provided, by means of which the application device 112 and/or the workpiece 102 to be treated can be moved, in particular moved linearly.

However, it is also conceivable that the workpiece to be treated can be moved, in particular moved linearly, in the treatment chamber 108 by means of the conveying device 124.

By means of the movement device 152 or the conveying device 124, the relative positions of the application units 114 can thus be changed relative to the workpiece 102 in order to be able to apply fluid to the workpiece 102 completely.

In this case, the application units 114 can be arranged so as to be distributed over a total length of the treatment chamber 108.

In the case of such an arrangement of the application units 114, it is particularly favorable if the workpiece 102 can be moved back and forth at least once by more than half the distance between two adjacent application units 114, so that fluid is applied to the workpiece 102 uniformly and/or completely as a result of the relative movement of the workpiece 102 relative to the application units 114.

Alternatively thereto, it can be provided for the application units 114 to be arranged around the workpiece 102 in a portal-like manner on only one region thereof, and for it to be possible for fluid to act on the workpiece 102 ultimately over the entire surface on account of the movement by means of the movement device 152.

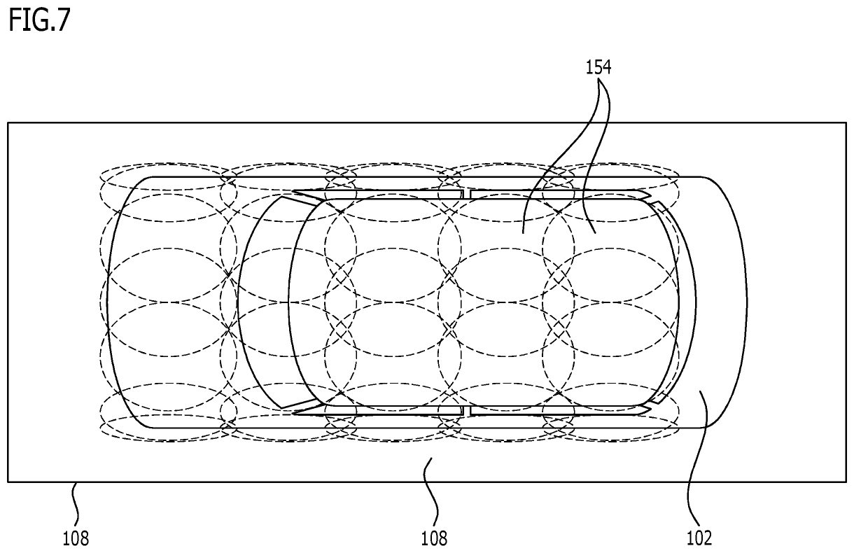

As can be seen in particular from FIG. 7, overall spray patterns 154 can be produced by means of each application unit 114 of the application device 112, said entire spray patterns preferably overlapping on the workpiece 102 and thus enabling at least approximately uninterrupted wetting of the workpiece 102 with fluid.

In particular, a uniform application of fluid can be provided, it preferably being possible for a similar quantity of the fluid to be applied over the entire surface of the workpiece 102 with at least approximately identical process parameters, in particular drop sizes and impact velocities.

By means of the movement device 152 or the conveying device 124, a movement, in particular a movement of the workpiece 102, for example a linear movement, by at least approximately 100 mm, preferably at least approximately 200 mm, and/or at most approximately 1000 mm, for example at most approximately 700 mm, in particular at most approximately 500 mm, is possible.

Alternatively or in addition to a linear movement, a tilting and/or rotational movement of the application device 112 and/or of the workpiece 102 can preferably be provided by means of the movement device 152.

The application units 114 designed, for example, as spray nozzles 116 can be, for example, full cone nozzles, in particular with a wide spray cone and/or nozzles with, for example, a narrower spray cone, but in this case a higher discharge range and/or exit speed. For example, flat spray nozzles can be provided for applying fluid to surfaces arranged further away, for example in edge regions and/or to an engine cover and/or a trunk lid.

The application device 112 preferably comprises different portions, in particular different distributor pipes for supplying fluid to the application units 114, it being possible for the different portions, in particular the different distributor pipes, to be subjected to different pressures, in particular in order to produce different spray and/or atomization patterns and/or spray images and/or atomization images by means of the application units 114.

In particular when a movement device 152 is provided for moving the application device 112, a flexible supply line for supplying fluid to the application device 112 can preferably be provided, for example an elastic tube.

The movement device 152 can preferably comprise a pneumatic cylinder (not shown) or another drive unit for generating the movement.

Otherwise, the third embodiment shown in FIGS. 5 to 7 corresponds, in terms of structure and function, to the embodiment shown in FIGS. 1 to 2, and therefore reference is made in this respect to the above description thereof.

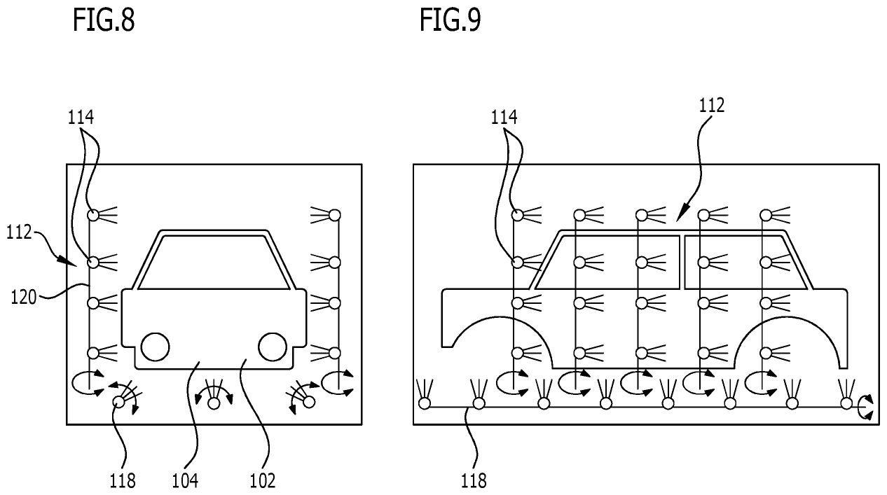

A fourth embodiment of a treatment system 100 shown in FIGS. 8 and 9 differs from the third embodiment shown in FIGS. 5 to 7 substantially in that a plurality of vertical rows 120 and/or horizontal lines 118 of application units 114 are arranged so as to be rotatable as a whole, in particular in order to vary an exit direction of the fluid from the application units 114. Each row 120 and/or each line 118 is preferably assigned one distributor pipe, in each case, on which the application units 114 are arranged and which can be rotated as a whole, for rotation of the application units 114, or comprises at least one or more rotatable portions.

By means of the rotatable configuration, in particular a large-area application of fluid to the workpiece 102 can be achieved.

In particular an angle of rotation of at least approximately +20°, preferably at least approximately +30°, starting from a central position of the application units 114, is provided.

The rotation of the application units 114 can take place for example pneumatically and/or electrically. For example, a mechanical linkage can be provided for causing a movement, in particular a plurality of application units 114, preferably a plurality of vertical rows 120 and/or a plurality of horizontal lines 118, being movable simultaneously and/or jointly, in particular synchronously.

Otherwise, the fourth embodiment of the treatment system 100 shown in FIGS. 8 and 9 corresponds, in terms of structure and function, to the third embodiment shown in FIGS. 5 to 7, and therefore reference is made, in this respect, to the above description thereof.

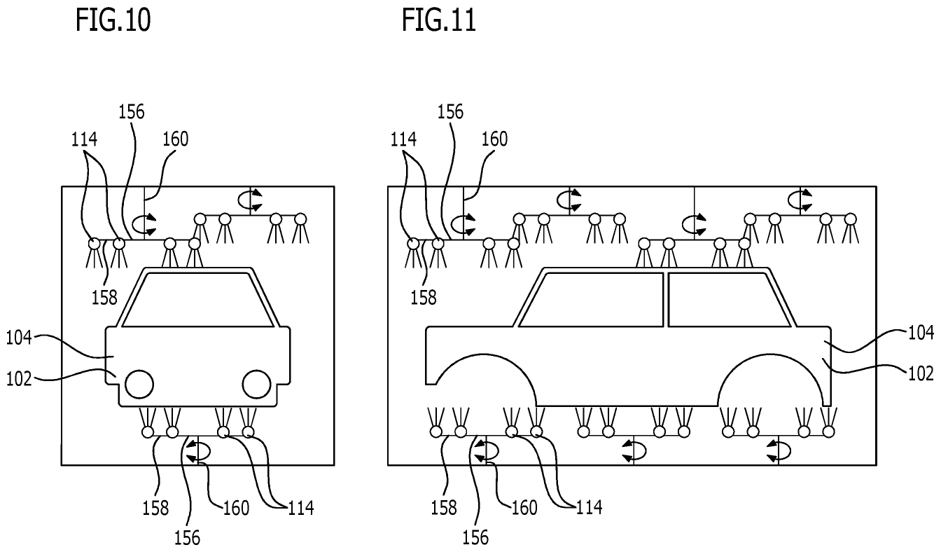

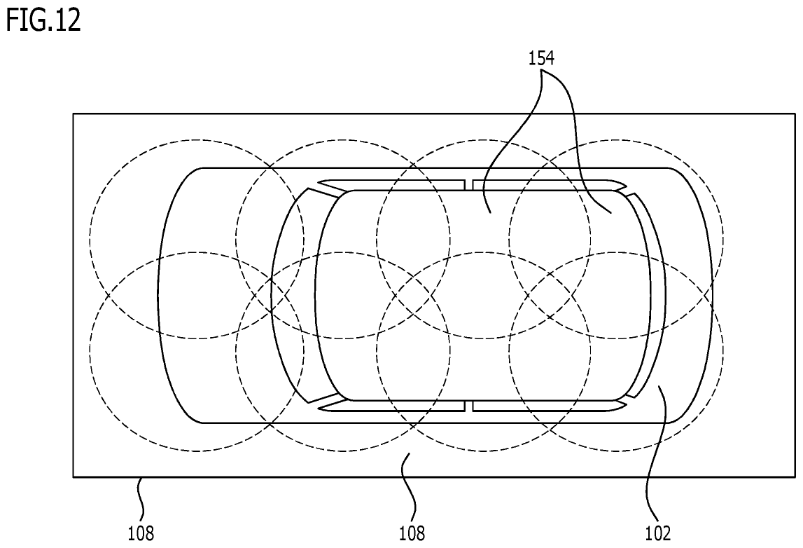

A fifth embodiment of a treatment system 100 shown in FIGS. 10 to 12 differs from the embodiment shown in FIGS. 8 and 9 substantially in that the application device 112 comprises a plurality of distributor devices 156 which form rotors 158 and are rotatable about for example at least approximately vertical axes of rotation 160.

The distributor devices 156 in particular each have a plurality of application units 114, which are arranged, for example, in a row.

The rotation of the distributor device 156 about the axis of rotation 160 results in a temporally varying application of the fluid to the workpiece 102.

Preferably, a plurality of such rotors 158 are provided, which rotors are arranged in particular at different heights in order to enable an overlap of the spray patterns or atomization patterns and thus a uniform wetting of the workpiece 102 with fluid.

The application units 114 are in particular arranged above the workpiece 102 and/or below the workpiece 102.

Optionally, however, further distributor devices 156 rotating about horizontal axes of rotation 116 can also be provided, by means of which, for example, side surfaces of the workpiece 102 could be acted upon.

Otherwise, the fifth embodiment of the treatment system 100 shown in FIGS. 10 to 12 corresponds, in terms of structure and function, to the fourth embodiment shown in FIGS. 8 and 9, and therefore reference is made, in this respect, to the above description thereof.

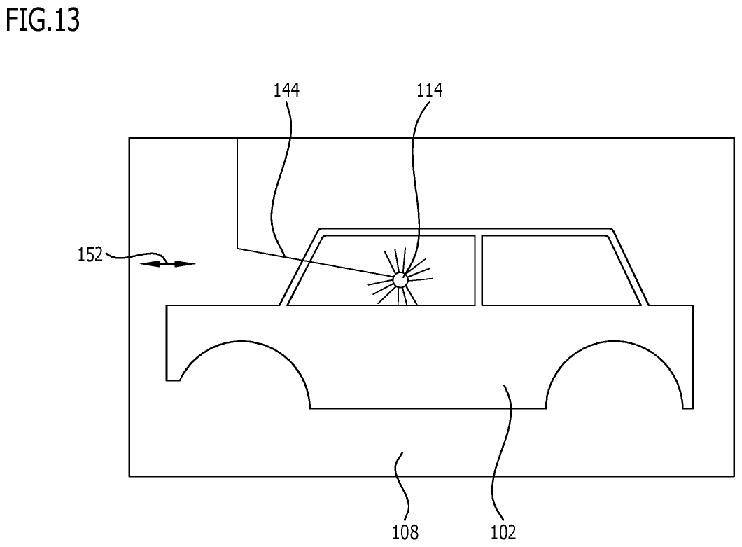

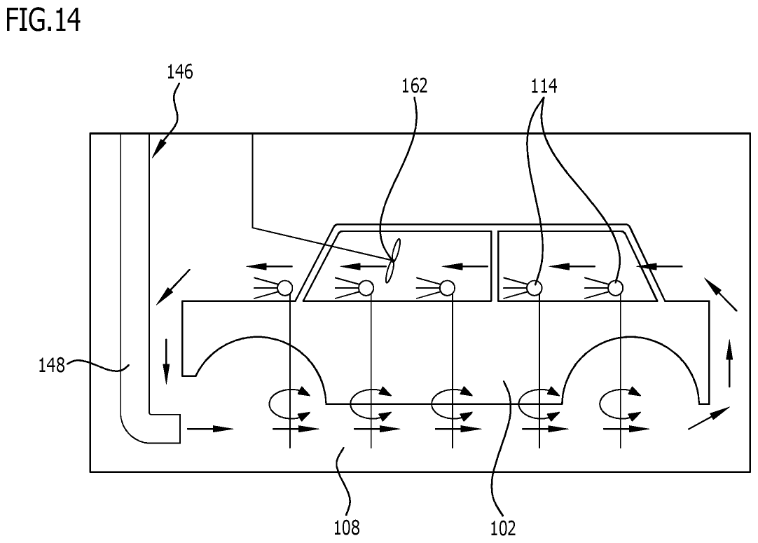

FIG. 13 shows an optional additional application unit 114 which, in functional terms, corresponds to the application lance 144 shown in FIGS. 1 and 2 and serves to apply fluid to the interior of the workpiece 102.

In this case, too, a movement device 152 can be provided, for example in order to insert the application lance 144 into the interior of the workpiece 102. Alternatively thereto, the workpiece 102 can also be introduced into the treatment chamber 108, for example by means of the conveying device 124, such that the application lance 144 projects into the interior of the workpiece 102 in an end position or treatment position of the workpiece 102.

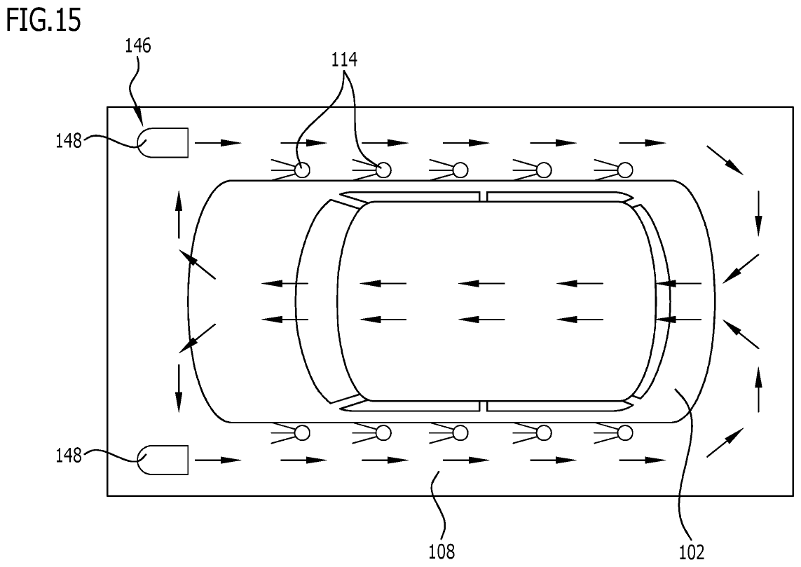

A sixth embodiment of a treatment system 100 shown in FIGS. 14 and 15 differs from the second embodiment shown in FIGS. 3 and 4 substantially in that two flood pipes 148 are provided for supplying fluid to the treatment chamber 108 on both sides and/or symmetrically.

The flood pipes 148 are in particular arranged such that the inflowing fluid flows along an outer side of the workpiece 102 and is then returned in a central region, said fluid flowing in particular through the workpiece 102.

One or more application units 114 can serve for the additional supply of fluid and/or for driving a fluid flow. A for example lance-like stirring device 162 which projects into the interior of the workpiece 102 can also be provided, for example in order to optimize and/or drive a flow in the interior of the workpiece 102.

Otherwise, the sixth embodiment of the treatment system 100 shown in FIGS. 14 and 15 corresponds, in terms of structure and function, to the embodiment shown in FIGS. 3 and 4, such that reference is made to the above description thereof.

### LIST OF REFERENCE SIGNS

100 Treatment system
102 Workpiece
104 Vehicle body
106 Enclosure
108 Treatment chamber
110 Treatment station
112 Application device
114 Application unit
116 Spray nozzle
118 Line
120 Row
122 Nozzle matrix
124 Conveying device
126 Clocked conveying device
128 Access opening
130 Closing device
132 Feed tank
134 Discharge tank
138 Pump
Processing device
140 Cleaning device
142 Temperature control device
144 Application lance
146 Flooding device
148 Flood pipe
150 Top wall
152 Movement device
154 Overall spray pattern
156 Distributor device
158 Rotor
160 Axis of rotation
162 Stirring device

1. A treatment system for treating workpieces, in particular for performing a fluid treatment on vehicle bodies, wherein the treatment system comprises the following:
an enclosure which surrounds a treatment chamber;
a conveying device, by which at least one workpiece can be introduced into the treatment chamber and/or can be guided through the treatment chamber and/or can be discharged from the treatment chamber;
an application device for applying fluid to the at least one workpiece.

2. The treatment system according to claim 1, wherein the application device includes one or more application units for applying fluid to the at least one workpiece, the one or more application units including spray nozzles and/or atomizing nozzles or being designed as spray nozzles and/or as atomizing nozzles.

3. The treatment system according to claim 1, wherein the treatment chamber is a single space in which only a single workpiece can be received at a given time, it preferably being provided that the workpiece can be introduced into the treatment chamber by the conveying device, in an insertion direction, and can be discharged from the treatment chamber counter to the insertion direction.

4. The treatment system according to claim 1, wherein the treatment chamber is provided on a plurality of sides with application units of the application device.

5. The treatment system according to claim 2, wherein the workpiece is movable, in particular linearly displaceable, in the treatment chamber by the conveying device or a movement device, relative to the application units of the application device.

6. The treatment system according to claim 5, wherein the application units are arranged so as to be distributed over a total length of the treatment chamber, and wherein the workpiece is movable relative to the application units by more than half the distance between two adjacent application units.

7. The treatment system according to claim 5, wherein the relative movement of the workpiece can be controlled and/or regulated by a proximity sensor, in particular a proximity sensor with a protection type IP69k, and/or an incremental encoder and/or in terms of time, in particular with specification of a movement sequence.

8. The treatment system according to claim 5, wherein the acceleration of the relative movement is adjustable, in particular in a range between 0.25 and 2 m/s².

9. The treatment system according to claim 1, wherein the treatment chamber includes a closing device for partially or completely closing an access opening, through which the at least one workpiece can be introduced into the treatment chamber and/or through which the at least one workpiece can be discharged from the treatment chamber, the closing device preferably being designed as a roller gate or a sliding gate or a lifting gate.

10. The treatment system according to claim 1, wherein the conveying device is a clocked conveying device, and wherein the at least one workpiece is spatially stationary, in particular fixed, in order to carry out a treatment, preferably by the conveying device and/or an additional fixing device.

11. The treatment system according to claim 1 wherein the treatment system includes a feed tank which is arranged in particular above the treatment chamber, it being possible for fluid to be supplied from the feed tank to the application device and to be applied to the at least one workpiece by the application device.

12. The treatment system according to claim 1, wherein the treatment system includes a discharge tank which is arranged in particular below the treatment chamber and into which fluid applied to the at least one workpiece can be discharged.

13. The treatment system according to claim 1, wherein the application device includes at least one application unit, in particular at least one application lance, which can be inserted or projects into an interior of the at least one workpiece and by which fluid can be applied to surfaces of the at least one workpiece facing the interior of the at least one workpiece.

14. The treatment system according to claim 1, wherein the enclosure can be flooded at least in part, in particular up to a height of at least approximately 40%, preferably at least approximately 60%, of a maximum spatial height of the enclosure and/or of the treatment chamber.

15. The treatment system according to claim 1, wherein the treatment is or includes a cleaning, in particular a degreasing, and/or a chemical and/or physical surface treatment.

16. A method for treating workpieces, in particular for performing a fluid treatment on vehicle bodies, wherein the method includes the following:
introducing at least one workpiece into a treatment chamber and/or conveying at least one workpiece through a treatment chamber;
applying fluid to the at least one workpiece by an application device.

17. The method according to claim 16, wherein fluid is applied at least to the outer surfaces of the at least one workpiece at least approximately uniformly and/or at least approximately simultaneously.

18. The method according to claim 16, wherein the fluid is applied to the at least one workpiece during a flooding process for at least partial flooding of the treatment chamber and/or during an emptying process after flooding has taken place.

19. The method according to claim 16, wherein the at least one workpiece is acted on by fluid in a first treatment chamber by spraying and/or atomizing, and wherein the at least one workpiece is subsequently acted on by the same fluid or another fluid in a second treatment chamber different from the first treatment chamber by flooding the second treatment chamber.
